(19) United States
(12) Patent Application Publication
(10) Pub. No.: US 2018/0294512 A1
(43) Pub. Date: Oct. 11, 2018

(54) BINDER FOR SECONDARY BATTERY ELECTRODE, SECONDARY BATTERY ELECTRODE COMPOSITION INCLUDING THE SAME, AND SECONDARY BATTERY USING THE SAME

(71) Applicant: LG CHEM, LTD., Seoul (KR)

(72) Inventors: Young Jae KIM, Daejeon (KR); Ye Cheol RHO, Daejeon (KR); Jung Woo YOO, Daejeon (KR); Jun Soo PARK, Daejeon (KR)

(73) Assignee: LG CHEM, LTD., Seoul (KR)

(21) Appl. No.: 15/765,421

(22) PCT Filed: Jul. 12, 2017
(86) PCT No.: PCT/KR2017/007474

§ 371 Date: Apr. 2, 2018

(30) Foreign Application Priority Data
Jul. 12, 2016 (KR) 10-2016-0088116
Jul. 11, 2017 (KR) 10-2017-0087738

(51) Int. Cl. H01M 10/0525; C08F 216/06; C08F 220/06; H01M 4/587; H01M 4/38; H01M 4/62; H01M 4/66; H01M 10/0569

(52) U.S. Cl. CPC H01M 10/0525; C08F 216/06; C08F 220/06; H01M 4/587; H01M 2004/027; H01M 4/622; H01M 4/661; H01M 10/0569; H01M 4/38

(57) ABSTRACT

The present invention relates to a binder for a secondary battery electrode, a secondary battery electrode composition including the binder, and a secondary battery using the same. The binder includes a copolymer having a polyvinyl alcohol (PVA) and an ionically substituted acrylate. The binder may have an excellent electrode adhesive force, prevent an electrode deformation caused by the expansion and contraction of an electrode active material, and improve charge/discharge life characteristics, and further, simplify manufacturing processes.

### CROSS-REFERENCE TO RELATED APPLICATIONS

This application claims the benefit of Korean Patent Application No. 10-2016-0088116, filed on Jul. 12, 2016, and Korean Patent Application No. 10-2017-0087738, filed on Jul. 11, 2017, in the Korean Intellectual Property Office, the disclosure of which are incorporated herein in their entireties by reference.

### TECHNICAL FIELD

### Technical Field

The present invention relates to a binder for a secondary battery electrode, a secondary battery electrode composition including the binder, and a secondary battery using the same, the binder being capable of having an excellent electrode an adhesive force, preventing the deformation of an electrode caused by the expansion and contraction of an electrode active material, improving charge/discharge life characteristics, and furthermore simplifying a preparation process.

### Background Art

Demands for secondary batteries as an energy source significantly increase as technology development and demands for mobile devices increase, and thus various researches on batteries capable of meeting with various demands have been carried out. Particularly, as a power source for such devices, a lithium secondary battery having excellent life and cycle characteristics while having high energy density is being actively studied.

The lithium secondary battery means a battery in which a non-aqueous electrolyte containing lithium ions is contained in an electrode assembly. Here, the electrode assembly includes a positive electrode having a positive electrode active material capable of intercalation/deintercalation of lithium ions, a negative electrode having a negative electrode active material capable of intercalation/deintercalation of lithium ions, and a microporous separator interposed between the positive electrode and negative electrode.

A lithium metal oxide is used as a positive electrode active material for a lithium secondary battery, and a lithium metal, a lithium alloy, a crystalline or amorphous carbon, or a carbon composite are used as a negative electrode active material for a lithium secondary battery. The active material is coated, in an appropriate range of thickness and length, on an electrode current collector, or the active material itself is coated in a film form and wrapped or laminated together with the separator, which is an insulator, to form an electrode group. The electrode group is then placed into a can or similar container, followed by introducing an electrolyte to manufacture a secondary battery.

The theoretical capacity of a battery varies with kinds of negative electrode active materials, but there is a phenomenon in which the charge/discharge capacity is generally reduced as a cycle progresses.

This phenomenon occurs due to a change in an electrode volume induced by the progress of charging and discharging of a battery, thereby separating between electrode active materials or between the electrode active material and the electrode current collector to cause the electrode active material to be unable to fulfill a function. Furthermore, electrodes are deformed, for example, a solid electrolyte interface (SEI) film is damaged, due to a change in an electrode volume during charging/discharging to cause lithium included in an electrolyte solution to be consumed much more, thereby leading to deterioration of electrode active materials and batteries owing to depletion of the electrolyte solution.

Previously used binders such as carboxymethylcellose (CMC) and styrene butadiene rubber (SBR) have a low adhesive force to become a major cause in deterioration of battery characteristics as charging/discharging proceeds.

Therefore, binders and electrode materials, which may prevent, with a strong adhesive force, deterioration caused by separation of the active material even when the volume of the electrode is changed as charging/discharging proceeds, and which may improve structural stability of electrodes to achieve improvement in battery performance, are desperately desired in the art.

### DISCLOSURE OF THE INVENTION

### Technical Problem

The present invention is directed to providing a binder for a secondary battery electrode, a secondary battery electrode composition including the binder, and a secondary battery using the same, the binder being capable of suppressing expansion of electrode active materials, suppressing separation of active materials and deformation of electrodes with good adhesive force as charging/discharging proceeds, so that charge/discharge life characteristics can be improved and a preparation process can be simplified.

### Technical Solution

The present invention provides a binder for a secondary battery electrode, the binder being a copolymer including a repeating unit derived from a polyvinyl alcohol (PVA) and a repeating unit derived from an ionically substituted acrylate.

Also, the present invention provides a secondary battery electrode composition including an electrode active material, a conductive material, a binder, and a solvent, wherein the binder is a binder according to the present invention.

Further, the present invention provides a secondary battery including a positive electrode, a negative electrode, a separator interposed between the positive electrode and negative electrode, and an electrolyte, wherein the negative electrode is obtained by coating an electrode current collector with the secondary battery electrode composition according to the present invention.

### Advantageous Effects

A binder according to the present invention may have an adhesive force superior to typical binders such as carboxymethylcellulose (CMC) and styrene butadiene rubber (SBR) to suppress the separation between the electrode active materials and between the electrode and the current collector. In addition, a single solution binder can be prepared instead of a CMC/SRB dual binder, thereby simplifying the preparation process.

Also, a thinner and more uniform solid electrolyte interface (SEI) film may be formed, and bind more to the electrode active material, thereby suppressing expansion of the electrode active material during charging/discharging, and also preventing deformation of electrodes to ensure excellent charge/discharge life characteristics.

### BRIEF DESCRIPTION OF THE DRAWINGS

FIG. 1 is a graph showing an electrode adhesive force of negative electrodes for the secondary battery manufactured according to examples and comparative examples of the present invention.

FIG. 2 is a graph showing XPS analysis results of negative electrodes for the secondary battery manufactured according to examples and comparative examples of the present invention.

FIG. 3 is a graph showing analysis results of single SiO (bare SiO), SiO/CMC, SiO/Example 1, and SiO/Example 2 by using TGA.

FIG. 4 is a graph showing capacity measurement results according to a discharge rate of the secondary battery manufactured according to examples and comparative examples of the present invention.

FIG. 5 is a graph showing life characteristics of the secondary battery manufactured according to examples and comparative examples of the present invention.

### MODE FOR CARRYING OUT THE INVENTION

Hereinafter, the present invention will be described in more detail to allow for a clearer understanding of the present invention. It will be also understood that words or terms used in the specification and claims shall not be interpreted as the meaning defined in commonly used dictionaries. It will be further understood that the words or terms should be interpreted as having a meaning that is consistent with their meaning in the context of the relevant art and the technical idea of the invention, based on the principle that an inventor may properly define the meaning of the words or terms to best explain the invention.

<Binder for Secondary Battery Electrode>

The present invention relates to a binder for a secondary battery electrode, the binder being a copolymer including a repeating unit derived from a polyvinyl alcohol (PVA) and a repeating unit derived from an ionically substituted acrylate.

Conventionally, negative electrodes for a secondary battery may be obtained through both aqueous preparation and non-aqueous preparation, and for the aqueous preparation, carboxymethylcellose (CMC) and styrene butadiene rubber (SBR) were generally used as binders. Carboxymethylcellose (CMC) allowed a prepared slurry to have phase stability, and styrene butadiene rubber (SBR) played a role in obtaining an adhesive force inside electrodes. In this way, conventionally, carboxymethylcellose (CMC) for obtaining phase stability and styrene butadiene rubber (SBR) for obtaining an adhesive force had to be used together, so that the preparation process was complicated. In addition, this particularly caused a problem that carboxymethylcellose (CMC) had a limitation in increasing solid matters in preparation of an electrode slurry because of a solubility limit.

Also, cracking between particles and the short-circuiting between electrodes occur due to the volume change of electrodes caused by charging/discharging of batteries, and particularly, negative electrode active materials (e.g., materials forming intermetallic compounds with lithium, such as silicon, tin, and oxides thereof) recently used so as to obtain high capacity cause crystalline structures to be changed when lithium was absorbed and stored, thereby expanding the volume much more. Therefore, when only conventional binders were used, there have been problems of deterioration of batteries and degradation of life characteristics of batteries as the charge/discharge proceeds.

However, although the binder for a secondary battery electrode according to the present invention, which includes a copolymer containing a repeating unit derived from a polyvinyl alcohol (PVA) and a repeating unit derived from an ionically substituted acrylate, is a single binder, this binder may ensure a phase stability and an adhesive force, thereby being capable of simplifying the preparation process, increasing solid matters of an electrode slurry, suppressing an electrode active material from being expanded, preventing electrode deformation despite the volume change of electrodes by virtue of an excellent adhesive force, and ensuring excellent charge/discharge life characteristics. In particular, the binder for a secondary battery electrode according to the present invention may have a repeating unit derived from an ionically substituted acrylate, and thus an adhesive force may be remarkably improved in comparison with the case of ionically unsubstituted acrylate.

The repeating unit derived from an ionically substituted acrylate may be formed through processes of copolymerizing an alkylacrylrate with a monomer, and then adding an excessive ionic aqueous solution to perform substitution. In this case, in the final copolymer structure, the repeating unit derived from an ionically substituted acrylate may be understood as a repeating unit derived from the ionically substituted acrylate based on an ionically substituted final polymer, regardless of the alkylate (e.g., alkyl alkylate) used as a raw material.

The copolymer including the repeating unit derived from a polyvinyl alcohol (PVA) and the repeating unit derived from an ionically substituted acrylate may be represented by Formula 1 below.

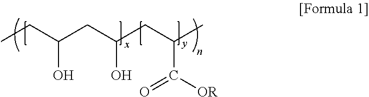

In Formula 1, R may be each independently at least one positive ion of metal selected from the group consisting of Na, Li, and K; the x may be each independently an integer of 2,000 to 3,000; the y may be each independently an integer of 1,000 to 2,000; and the n may be an integer of 1,000 to 5,000.

The copolymer may be a block copolymer formed by including the repeating unit derived from a polyvinyl alcohol (PVA) and the repeating unit derived from an ionically substituted acrylate. In other words, the copolymer may have a structure in which the repeating unit block derived from a polyvinyl alcohol (PVA) and the repeating unit block derived from an ionically substituted acrylate are connected linearly to form a main chain.

The repeating unit derived from a polyvinyl alcohol (PVA) and the repeating unit derived from an ionically substituted acrylate mean a structure obtained through an addition reaction of double bond-containing polyvinyl alcohol and acrylate monomers. In the acrylate, a substituent bonded to an ester in the final copolymer structure may not be necessarily identical to a substituent in the raw material.

The ionically substituted acrylate may be more preferably at least one selected from the group consisting of sodium acrylate and lithium acrylate, and most preferably, sodium acrylate.

The sodium acrylate or lithium acrylate may be formed by copolymerizing an alkyl acrylate with monomers, and then adding an excessive sodium ion aqueous solution or lithium ion aqueous solution to perform substitution. In this case, in the final copolymer structure, the repeating unit derived from an acrylate may be understood as the repeating unit derived from a sodium acrylate or the repeating unit derived from a lithium acrylate, regardless of an alkylate (e.g., alkyl alkylate) used as a raw material.

The copolymer may include the repeating unit derived from a polyvinyl alcohol (PVA) and the repeating unit derived from an ionically substituted acrylate at a weight ratio of 6:4 to 8:2.

When the repeating unit derived from a polyvinyl alcohol (PVA) and the repeating unit derived from an ionically substituted acrylate are included in the weight ratio range above, a polymer adsorbed onto particles by the polyvinyl alcohol having a hydrophilic group to maintain a proper dispersibility, and the adsorbed polymer forms a film after drying to develop a stable adhesive force. Also, the resulting film may have advantages of improving battery performance while forming an SEI film having high uniformity and density during charging/discharging of the battery.

When the polyvinyl alcohol (PVA) is included in an amount less than the above-described weight ratio range, a hydrophilic property may be weakened to cause solid matters soluble in water to be reduced, so that the binder has a strong tendency to float toward the electrode surface to affect the performance. The copolymer may be adsorbed onto the surface of a hydrophobic active material, but may be problematic in dispersion. On the contrary, when the polyvinyl alcohol (PVA) is included in an amount larger than the above-described weight ratio range, a number of bubbles are generated due to the intrinsic properties of the PVA during dissolving or mixing, and particles are adsorbed on the bubbles and agglomerate, thereby resulting in generation of undispersed giant particles, which may exhibit inferior cell performance and cause various problems.

The copolymer may have a weight average molecular weight of 100,000 to 500,000.

When the weight average molecular weight of the copolymer is less than 100,000, the dispersion force is weakened and the possibility of agglomeration of the particles is increased, thus making it difficult to improve the adhesion and the charge/discharge life characteristics. When the weight average molecular weight of the copolymer exceeds 500,000, the copolymer is difficult to be dissolved at a high concentration so that it is inappropriate to increase solid matters of the slurry, and gelation is highly likely to occur during polymerization.

<Secondary Battery Electrode Composition>

A secondary battery electrode composition according to an embodiment of the present invention includes an electrode active material, a conductive material, a solvent, and the binder according to the present invention.

The electrode composition including the binder according to the embodiment of the present invention may be preferably used in preparation of a negative electrode.

As the electrode active material used in preparation of the negative electrode, carbon-based material, lithium metal, silicon, tin, or the like, which may conventionally occlude and release lithium ions, may be used. More preferably, carbon-based material may be mainly used, and the carbon-based material is not particularly limited to, but may be, for example, at least any one selected from the group consisting of soft carbon, hard carbon, natural graphite, artificial graphite, kish graphite, pyrolytic carbon, mesophase pitch based carbon fiber, mesocarbon microbeads, mesophase pitches, and petroleum or coal tar pitch derived cokes.

Also, in order to achieve a higher capacity, the electrode active material may further include a Si-based material in addition to the carbon-based material, and, for example, may further include SiO.

The Si-based material may be included in an amount of 5 wt % to 20 wt %, based on the total weight of the electrode active material. When the Si-based material is included in an amount of less than 5 wt %, the capacity increase range according to an input ratio is not large, so that a high-capacity electrode may be difficult to be achieved. When the Si-based material is included in an amount of greater than 20 wt %, there may be a problem that volume expansion due to charging is so large that the electrode may be deformed and life characteristics may remarkably deteriorated.

The Si-based material has a high capacity, that is, has a theoretical capacity of about 10 times that of the carbon-based material, so that a high capacity battery may be realized. However, when absorbing and storing lithium, the Si-based material causes a crystal structure to be changed to lead to a large volume expansion, and thus has a problem in that, as the charge/discharge proceeds, such a volume change due to charging causes separation between active materials and from the current collector, deformation of the electrode, and the like, leading to deterioration in life characteristics.

However, according to an embodiment of the present invention, the copolymer binder having a polyvinyl alcohol and an acrylate is included, thereby suppressing volume expansion of the electrode active material, preventing separation between active materials and from the current collector with a strong adhesive force, forming an SEI film having a small thickness and high density to suppress the deformation of the electrode, and improving charge/discharge life characteristics.

The conductive material is not particularly limited as long as being generally used in the art, but may employ, for example, artificial graphite, natural graphite, carbon black, acetylene black, ketjen black, denka black, thermal black, channel black, carbon fiber, metal fiber, aluminum, tin, bismuth, silicon, antimony, nickel, copper, titanium, vanadium, chromium, manganese, iron, cobalt, zinc, molybdenum, tungsten, silver, gold, lanthanum, ruthenium, platinum, iridium, titanium oxide, polyaniline, polythiophene, polyacetylene, polypyrrole, a combination thereof, or the like. Generally, the carbon black-based conductive material may be often used as the conductive material.

The solvent may preferably include an aqueous solvent, and the aqueous solvent may be water. The binder according to an embodiment of the present invention may be water-soluble or water-dispersible.

However, in some cases, the solvent may use at least one selected from among N.N-dimethylformamide, N.N-dimethylacetamide, methyl ethyl ketone, cyclohexanone, ethyl acetate, butyl acetate, cellosolve acetate, propylene glycol monomethyl ether acetate, methyl cellosolve, butyl cellosolve, methyl carbitol, butyl carbitol, propylene glycol monomethyl ether, diethylene glycol dimethyl ether, toluene, and xylene, and may also be used by being mixed with water. The content of the solvent is not particularly limited and may be set such that slurry has a moderate viscosity.

In the binder according to an embodiment of the present invention, when a repeating unit derived from an acrylate is in the form of a salt, for example, a sodium acrylate or a lithium acrylate, sodium or lithium positive ions may be present in a co-existing state of being dissociated or ionized when the binder is dissolved in the solvent.

In addition to the above-described components, the electrode composition may further include additives for improving additional properties. Such additives may include crosslinking accelerators, dispersants, thickeners, fillers, etc., which are commonly used. Each of the additives may be used by being pre-mixed with the electrode composition in preparation of the electrode composition, or may be prepared separately and used independently. Ingredients of the additives to be used are determined by the ingredients of the electrode active material and the binder, and in some cases, the additives may be unused.

However, the electrode composition may be used by mixing the binder of the present invention and binders such as carboxymethylcellulose (CMC) and styrene butadiene rubber (SBR) which have been conventionally used.

The electrode composition according to an embodiment of the present invention may include 1 wt % to 10 wt % of the binder according to the present invention, based on the total weight of solid matters excluding the solvent.

When the binder is included in an amount of less than 1 wt %, the amount of the binder may be significantly small, thereby being unable to achieve the adhesive force of the electrode targeted by the present invention; and when the amount of the binder exceeds 10 wt %, the amount of the active material may be small, so that the capacity and output characteristics of batteries are deteriorated and the resistance is increased.

Also, in the electrode composition according to an embodiment of the present invention, solid matters including the electrode active material, the conductive material, and the binder may be present in an amount of 45 wt % or more, based on the total weight.

Conventional binders (e.g., carboxymethylcellulose (CMC)) which have been generally used in preparation of a negative electrode slurry in water have limitations in increasing the solid matters of a slurry because of a solubility limit. However, when using the binder according to the present invention, the content of solid matters may be increased due to a high solubility compared to the case of using conventional binders, and the content of solid matters may be preferably included in an amount of 45 wt % or more.

When the content of solid matters is increased, the viscosity of the slurry increases so that migration of the binder toward the surface may be reduced to obtain a more uniform electrode, and an increase in an adhesive force between the electrode and the current collector may also be expected. Also, what the content of solid matters is high means that the content of a solvent is low, so that the drying energy for removing the solvent may be saved, thereby reducing a process cost.

<Secondary Battery>

The present invention provides a lithium secondary battery including a positive electrode, a negative electrode, an electrolyte, and a separator, the negative electrode being a negative electrode manufactured by using a binder for a secondary battery electrode according to the present invention.

The lithium secondary battery of the present invention may be manufactured by conventional methods known in the art. For example, the lithium secondary battery may be manufactured by placing the separator between the positive electrode and the negative electrode, and then adding the electrolyte in which a lithium salt is dissolved.

The electrodes for the lithium secondary battery may also be manufactured by conventional methods known in the art. For example, the electrodes may be manufactured in such a way that a slurry is prepared by mixing and stirring a solvent, as necessary, a binder, a conductive material, and a dispersant in a positive electrode active material or a negative electrode active material, and then the slurry is applied (coated) on a metallic current collector, compressed and dried to form an active material layer.

The positive electrode active material according to an embodiment of the present invention may use preferably lithium transition metal oxides, and may be, for example, one or more mixtures selected from the group consisting of LiₓCoO₂ (0.5<x<1.3), LiₓNiO₂ (0.5<x<1.3), LiₓMnO₂ (0.5<x<1.3), LiₓMn₂O₄ (0.5<x<1.3), Liₓ(NiₐCo_{b}Mn_{c})O₂ (0.5<x<1.3, 0<a<1, 0<b<1, 0<c<1, a+b+c=1), LiₓNi_{1-y}Co_{y}O₂ (0.5<x<1.3, 0<y<1), LiₓCo_{1-y}Mn_{y}O₂ (0.5<x<1.3, 0≤i<1), LiₓNi_{1-y}Mn_{y}O₂ (0.5<x<1.3, 0≤y<1), Liₓ(NiₐCo_{b}Mn_{c})O₄ (0.5<x<1.3, 0<a<2, 0<b<2, 0<c<2, a+b+c=2), LiₓMn_{2-z}Ni_{z}O₄ (0.5<x<1.3, 0<z<2), LiₓMn_{2-z}Co_{z}O₄ (0.5<x<1.3, 0<z<2), LiₓCoPO₄ (0.5<x<1.3) and LiₓFePO₄ (0.5<x<1.3).

As described in the electrode composition of the present invention, the negative electrode active material may typically use a carbon-based material, lithium metal, silicon, tin, or the like, which enables occlusion and release of lithium ions. Preferably, the carbon-based material may be mainly used, and the carbon-based material may further include a Si-based material.

The electrodes, i.e., the positive electrode and the negative electrode may be manufactured by coating an electrode current collector with a secondary battery electrode composition according to an embodiment of the present invention to form an active material layer.

The electrode current collector may use a metal which has high conductivity and to which a slurry of the electrode composition may easily adhere, and may use any metal as long as the metal has no reactivity in the voltage range of the battery. Non-limiting examples of the positive electrode current collector include aluminum, nickel, a foil prepared by a combination thereof, and the like, and non-limiting examples of the negative electrode current collector include copper, gold, nickel, copper alloy, a foil prepared by a combination thereof, and the like.

The separator included in the lithium secondary battery according to the present invention may be used in such a way that a conventional porous polymer film, for example, a porous polymer film made of a polyolefin-based polymer such as an ethylene homopolymer, a propylene homopolymer, an ethylene/butene copolymer, an ethylene/hexene copolymer, and an ethylene/methacrylate copolymer is used alone or in a laminated form thereof, or a conventional porous nonwoven fabric, for example, a nonwoven fabric made of a glass fiber having a high melting point, or a polyethylene terephthalate fiber is used. However, the separator is not limited thereto.

The electrolyte included in the lithium secondary battery according to the present invention may be an organic solvent mixture of at least one selected from the group consisting of propylene carbonate (PC), ethylene carbonate (EC), diethyl carbonate (DEC), dimethyl carbonate (DMC), dipropyl carbonate (DPC), dimethyl sulfoxide, acetonitrile, dimethoxyethane, diethoxyethane, tetrahydrofuran, N-methyl-2-pyrrolidone (NMP), ethylmethyl carbonate (EMC), gamma-butyrolactone (GBL), fluoroethylene carbonate (FEC), methyl formate, ethyl formate, propyl formate, methyl acetate, ethyl acetate, propyl acetate, pentyl acetate, methyl propionate, ethyl propionate, ethyl propionate and butyl propionate.

Also, the electrolyte according to the present invention may further include a lithium salt, and a negative ion of the lithium salt may be at least one selected from the group consisting of F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, F₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃ (CF₂)₇SO₃⁻, CF₃CO₂⁻, CH₃CO₂⁻, SCN⁻, and (CF₃CF₂SO₂)₂N⁻.

The lithium secondary battery according to the present invention may be a cylindrical, square-shaped, pouch-type secondary battery, but is not limited thereto as long as being a charge/discharge device.

Also, the present invention provides a battery module including the lithium secondary battery as a unit cell and a battery pack including the same.

The battery pack may be used as a medium- and large-sized device power supply of at least one selected from the group consisting of a power tool; an electric vehicle including an electric vehicle (EV), a hybrid electric vehicle (HEV), and a plug-in hybrid electric vehicle (PHEV); and a power storage system.

Hereinafter, embodiments of the present invention will be described in detail so that those skilled in the art can easily carry out the present invention. The present invention may, however, be embodied in many different forms and should not be construed as limited to the embodiments set forth herein.

### Example 1: Preparation of Binder for Secondary Battery Electrode

26.7 g of methyl acrylate and 53.3 g of poly(vinylalcohol) were placed into a 1 L reaction container provided with a heater, a cooler and a stirrer, dissolved in 320 g of benzene, and stirred. 2.256 g of benzoyl peroxide was added as an initiator, and 16.6 g of 1-butanethiol was added as a chain transfer reactant. Temperature was raised to 110° C. in a nitrogen atmosphere. After a reaction time of 4 hours, the initiator and the monomer were washed with methanol, and the resultant powder was then stirred in an excessive amount of n-hexane. An excessive amount of 5N NaOH solution was added into the solution being stirred, and the methyl in the methyl acrylate was substituted with a Na ion by stirring for 2 hours. After the reaction, the resultant mixture settled to obtain a powder, and the obtained powder was then dried in an oven at 60° C. to obtain a finally synthesized binder powder.

The weight average molecular weight of the prepared binder powder was 360,000, and the weight ratio between a repeating unit derived from poly(vinylalcohol) and a repeating unit derived from sodium acrylate was 0.67:0.33.

### Example 2

A binder was prepared in the same manner as in Example 1, except that 16 g of methyl acrylate and 64 g of poly(vinylalcohol) was used.

The weight average molecular weight of the prepared binder powder was 320,000, and the weight ratio between a repeating unit derived from poly(vinylalcohol) and a repeating unit derived from sodium acrylate was 0.78:0.22.

### Comparative Example 1

A binder was prepared in the same manner as in Example 1, except that the binder was prepared by washing without performing a Na substitution reaction.

The weight average molecular weight of the prepared binder powder was 360,000, and the weight ratio between a repeating unit derived from poly(vinylalcohol) and a repeating unit derived from methyl acrylate was 0.67:0.33.

### Example 3

1) Preparation of Negative Electrode for Secondary Battery

5.307 g of the binder powder prepared in Example 1 was placed in 100.833 g of water, and mixed at 70° C. and 1,500 rpm for 180 minutes by using a homomixer to prepare 5.0 wt % of a dispersion solution in which the binder is dispersed. 0.780 g of a carbon black-based conductive material and 68.75 g of water were added to 4.117 g of the binder dispersion solution, and mixed for dispersion by using the homomixer. 150.0 g of artificial graphite (negative electrode active material) of 20 μm was added to the solution dispersed, and mixed at 45 rpm for 40 minutes by using a planetary mixer to prepare a slurry. 92.02 g of the binder solution remaining in the slurry and 29.1 g of water was added, and mixed again at 45 rpm for 40 minutes by using the planetary mixer. The slurry thus prepared was a mixed solution (solid matter of 47.89 wt %) in which a negative electrode active material, a conductive material, and a binder were mixed at a weight ratio of 96.1:0.5:3.4.

The prepared negative electrode slurry was coated on a 20 μm thick negative electrode current collector such that an electrode loading (mg/cm²) became 10.9 mg per unit area, dried in a vacuum oven at 70° C. for 10 hours, and then rolled under a pressure of 15 Mpa between rolls heated to 50° C. to thereby prepare a negative electrode having a final thickness (current collector+active material layer) of 85.0 μm.

2) Manufacture of Secondary Battery

A positive electrode active material NMC, a carbon black-based conductive material, and a binder PVDF powder were mixed with a solvent N-methyl-2 pyrrolidone at a weight ratio of 92:2:6, respectively, to prepare a positive electrode slurry.

The prepared positive electrode slurry was coated on a 15 μm thick positive electrode current collector such that the electrode loading (mg/cm²) became 23.4 mg per unit area, dried in a vacuum oven at 120° C. for 10 hours, and then rolled under a pressure of 15 Mpa between rolls heated to 80° C. to manufacture a positive electrode having a final thickness (layer of current collector and active material) of 74.0 μm.

The manufactured negative electrode and positive electrode and a porous polyethylene separator were assembled by using a stacking method, and an electrolytic solution (ethylene carbonate (EC)/ethylmethyl carbonate (EMC)=1/2 (volume ratio), lithiumhexafluorophosphate (LiPF₆ 1 mole)) was introduced into the assembled battery to manufacture a lithium secondary battery.

### Example 4

A lithium secondary battery was manufactured in the same manner as in Example 3, except that 142.5 g of artificial graphite and 7.5 g of silicon oxide (SiO) were used as a negative electrode active material (containing 5 wt % of SiO based on the entirety of the negative electrode active material).

### Example 5

A lithium secondary battery was manufactured in the same manner as in Example 3, except that the binder prepared in Example 2 was used as a binder and 142.5 g of artificial graphite and 7.5 g of silicon oxide (SiO) were used as a negative electrode active material (containing 5 wt % of SiO based on the entirety of the negative electrode active material).

### Comparative Example 2

A lithium secondary battery was manufactured in the same manner as in Example 3, except that the binder prepared in Example 1 was used as a binder and 142.5 g of artificial graphite and 7.5 g of silicon oxide (SiO) were used as a negative electrode active material (containing 5 wt % of SiO based on the entirety of the negative electrode active material).

### Comparative Example 3

1.87 g of a CMC powder having a weight average molecular weight of 700,000 was added in 168.40 g of water, and mixed at 60° C. and 2,500 rpm for 120 minutes by using a homomixer to prepare 1.1 wt % of a dispersion solution in which CMC was dispersed. 0.780 g of a carbon black-based conductive material was added to 56.19 g of the CMC-dispersed solution, and mixed for dispersion by using a homomixer. 142.5 of an artificial graphite of 20 μm and 7.5 g of silicon oxide (SiO) were placed in the dispersion solution and 25.2 g of water was added. The resultant mixture was then mixed at 45 rpm for 45 minutes using a planetary mixer to prepare a slurry. 114.09 g of CMC solution remaining in the slurry was added, and mixed again at 45 rpm for 40 minutes using the planetary mixer. 8.48 g of an SRB solution (concentration of 40 wt %) was added to the slurry, and mixed at 800 rpm for 20 minutes by using a homomixer to thereby prepare a mixed solution (solid matter of 44.00 wt %) in which a negative electrode active material, a conductive material, CMC, and SBR were mixed at a weight ratio of 96.1:0.5:1.2:2.2.

The prepared electrode slurry was coated on a 20 μm thick negative electrode current collector such that an electrode loading (mg/cm²) became 11 mg per unit area, and dried in a vacuum oven at 70° C. for 10 hours, and then rolled under a pressure of 15 MPa between rolls heated to 50° C. to prepare a negative electrode having a final thickness (current collector+active material layer) of 86.0 μm.

A lithium secondary battery was manufactured in the same manner as in Example 3, except that the prepared negative electrode was used.

As can be seen from the examples and comparative examples above, when a single binder according to the present invention is used (Example 3) in comparison with the conventional case of using both CMC and SBR (Comparative Example 3), a mixing process may be simplified and a mixing time may be reduced, so that a preparation process may be simplified as a whole. In addition, it can be seen that a solid content of the final slurry was 44 wt % in Comparative Example 3, but a solid content was increased by about 4 wt % to 47.89 wt % in Example 3. The increase in the solid content accordingly provides advantageous effects of uniform distribution of the electrode binder, improvement in an adhesive force between the current collector and the active material, and reduction in battery price due to a decrease in process costs.

### Experimental Example 1: Evaluation of Adhesive Force

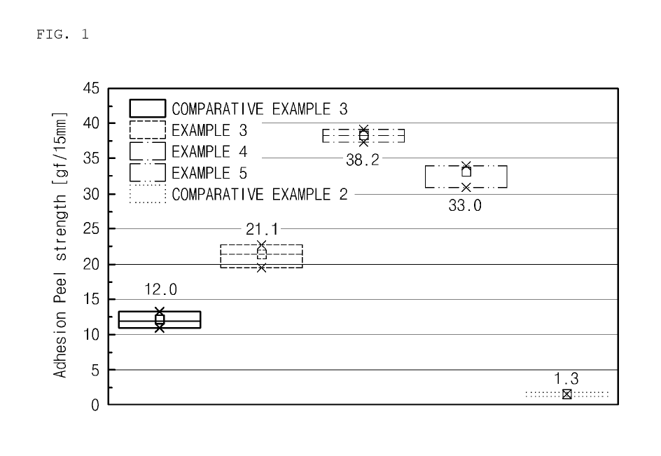

The generally known 180° peel test was used for the secondary battery negative electrodes manufactured in Examples 3 to 5 and Comparative Examples 2 and 3, the force (gf) applied until a tape was peeled off while pulling the tape at a speed of 10 mm/min was measured to compare adhesive forces of electrodes, and the results was shown in FIG. 1.

Referring to FIG. 1, the negative electrode of Comparative Example 3 using conventional CMC and SBR had an adhesive force of about 12.0 (gf/15 mm), whereas the negative electrode of Example 3 using a copolymer single binder according to an embodiment of the present invention had an adhesive force of about 21.1 (gf/15 mm), which proves that the adhesive force is significantly improved in Example 3. Also, the negative electrode of Example 4 further including SiO as a negative electrode active material exhibited much high adhesive force of 38.2 (gf/15 mm), and the negative electrode of Example 5 also exhibited 33.0 (gf/15 mm), which proves that the adhesive force in Example 4 was much highly improved compared to comparative examples. However, the negative electrode of Comparative Example 2 including an ionically unsubstituted alkyl acrylate exhibited much lower adhesive force than the conventional negative electrode using both CMC and SRB. It can be considered that the reason is because the binder itself does not have an ionic reactive group, and is thus unable to adhere to the surface of the current collector, thereby causing the adhesive force to be much deteriorated.

### Experimental Example 2: XPS Analysis Result for Negative Electrode

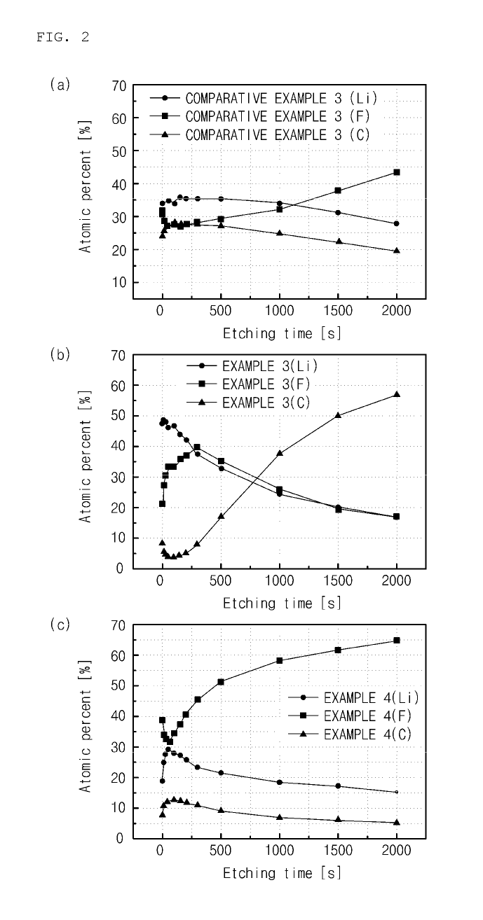

The thickness of a SEI film of each negative electrode surface in Examples 3 and 4 and Comparative Example 3 through Ar etching was observed. The thickness of the SEI film was determined through an etching time taken until the electrode surface of which 95% was composed of graphite was exposed, and the results were shown in FIG. 2.

Referring to FIG. 2, in Comparative Example 3 ((a) in FIG. 2) using CMC and SBR, the SEI film is observed to be formed thick such that a carbon (C) saturation point is invisible, whereas in Example 3 ((b) in FIG. 2) using the single binder according to an embodiment of the present invention, the saturation point of C is more likely to appear in comparison with Comparative Example 3 observed previously, and the carbon saturation point may be predicted to occur at an etching time of about 2000s or later on the graph. This indicates that the SEI film in Example 3 has a smaller thickness than that in Comparative Example 3. In Example 4 ((c) in FIG. 2) in which SiO is added, a carbon concentration saturation point occurs between 500 and 1000s and the negative electrode surface is thus exposed. Thus, it can be seen that the SEI film in Example 4 is formed to be thinner than those in Comparative Example 3 and Example 3.

Also, when observing a time point at which the concentrations of F and Li return to initial concentrations, it can be seen that Example 3 reaches the same concentration earlier by about 500 to 1000s or more than Example 4. Therefore, it can be seen that the SEI film of Example 4 has a higher density than that of Comparative Example 3.

In Comparative Example 3 in which the SEI film that is thick but have a low density is formed, the SEI film is easily broken by volume expansion of the negative electrode active material during charging and discharging and thus much more lithium present in the electrolyte is spent. This is a cause of deterioration of active materials and batteries which result from depletion of the electrolyte. On the contrary, the SEI film of Example 4 may have a high density in spite of small thickness, so that the SEI film is prevented from being broken even if the volume expansion of the active material occurs during charging and discharging, and charge/discharge characteristics are improved.

### Experimental Example 3: TGA Analysis Result

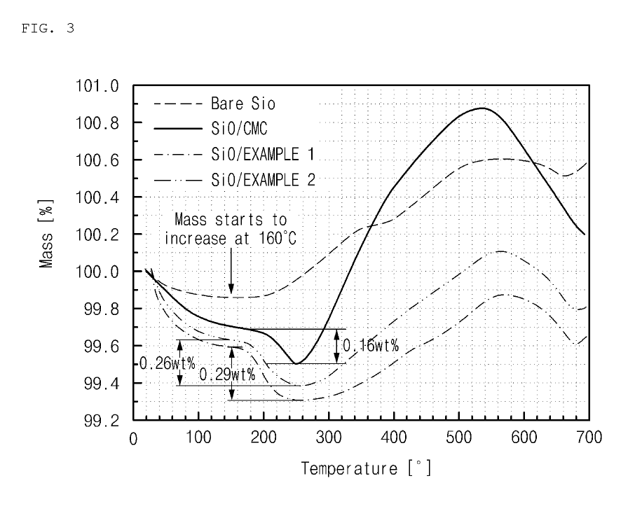

TGA analysis was performed on SiO/CMC; SiO/Example 1 binder; SiO/Example 2 binder; and single SiO (bare SiO) dispersed at a certain ratio. Since the mass of single SiO (bare SiO) is increased from 160° C. in an N₂ atmosphere, the reason why the mass of SiO/CMC, the mass of SiO/Example 1 binder, and the mass of SiO/Example 2 binder decreased and then increased is attributed to the fact that only SiO was left after the binder adsorbed onto the active material was completely decomposed to thereby increase the mass. The result is shown in FIG. 3.

Referring to FIG. 3, the mass of SiO/Example 1 binder decreased and then increased much larger than that of SiO/CMC, which demonstrates that the Example 1 binder was adsorbed onto the active material much more than the CMC was. In Example 2 in which a PVA content is increased, an adsorption amount is higher than those of conventional comparative examples, but is lower than that of Example 1. This is because Example 2 in which the number of hydrophilic functional groups is increased by increasing the PVA content has a structure in which the binder is less adsorbed onto the negative electrode active material having a hydrophobic surface. However, since both of the binders of Examples 1 and 2 exhibit higher values than those of comparative examples, using the binder according to the present invention allows the binder to be much more adsorbed onto SiO to assist in suppressing volume expansion of the active material.

### Experimental Example 4: Evaluation of Battery Performance

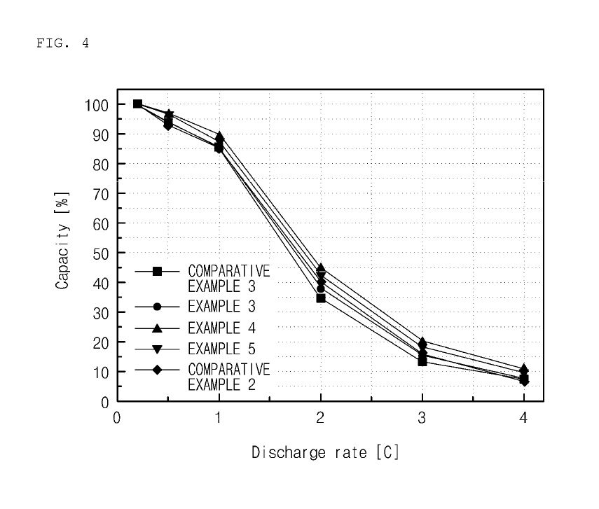

The results of evaluation of lithium secondary batteries manufactured in Examples 3 to 5 and Comparative Examples 2 and 3 for each charge rate are shown in Table 1 and FIG. 4.

TABLE 1

| Discharge | Discharge capacity [mAh@0.2 C] | | | | | |
|---|---|---|---|---|---|---|
| rate | 0.2 C | 0.5 C | 1.0 C | 2.0 C | 3.0 C | 4.0 C |
| Comparative | 100% | 94.9% | 84.7% | 40.4% | 15.7% | 7.4% |
| Example 2 | | | | | | |
| Comparative | 100% | 96.5% | 85.7% | 35.0% | 14.2% | 7.9% |
| Example 3 | | | | | | |
| Example 3 | 100% | 95.2% | 85.6% | 38.0% | 15.2% | 7.6% |
| Example 4 | 100% | 96.7% | 89.2% | 44.3% | 20.1% | 10.8% |
| Example 5 | 100% | 95.9% | 86.6% | 42.4% | 17.7% | 9.4% |

Referring to Table 1 and FIG. 4, it can be seen that the lithium secondary batteries of Examples 3 to 5 exhibit a higher discharge capacity than the lithium secondary battery of Comparative Example 3. Particularly, the lithium secondary batteries of Examples 4 and 5 including SiO exhibit a higher discharge capacity than the lithium secondary battery of Example 3 using only graphite as a negative electrode active material. It is considered that the reason is because the lithium secondary batteries of Examples 4 and 5 may exhibit a high adhesive force and a film is formed through good adsorption onto SiO while producing a more uniform and dense SEI film, thereby ensuring higher rate characteristics than in Example 3. Also, in Example 4 and Example 5 in which binders respectively composed of PVA and sodium acrylate at different weight ratios are used, nearly the same level of rate characteristics are exhibited. Comparative Example 2 in which a copolymer of PVA and an alkyl acrylate is used as a binder exhibits similar results to Comparative Example 3 overall, has low adhesive force, and has high resistance between the current collector and the electrode, thereby exhibiting similar performance to Comparative Example 3.

### Experimental Example 5: Evaluation of Life Characteristics

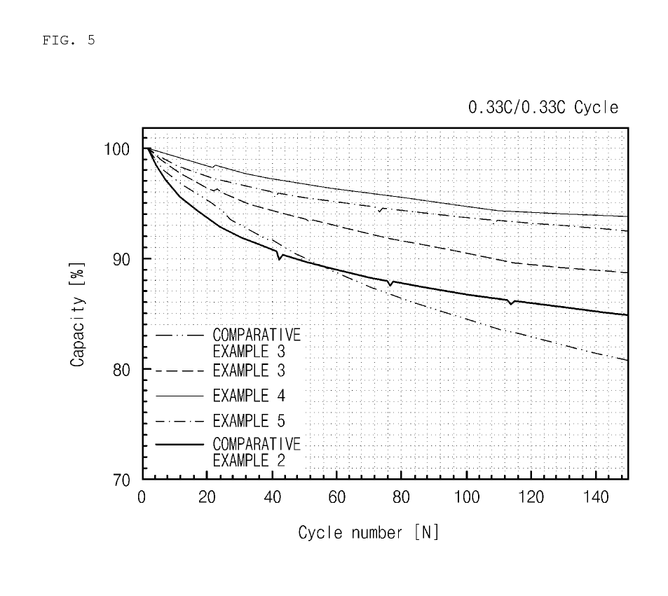

When 100 cycles of charging/discharging were performed on lithium secondary batteries manufactured in Examples 3 to 5 and Comparative Examples 2 to 3 under the conditions of charge/discharge 0.33C/0.33C, a capacity % at 100 cycles relative to 1 cycle is shown in FIG. 5.

Referring to FIG. 5, it can be seen that, compared to the lithium secondary battery of Comparative Example 3 using CMC and SBR, the lithium secondary batteries of Examples 3 to 5 using a copolymer single binder according to an embodiment of the present invention have improved life characteristics, and particularly, the life characteristics of the lithium secondary batteries of Examples 4 and 5 were significantly improved.

The lithium secondary battery of Comparative Example 2 using as a binder a copolymer of PVA and alkyl acrylate exhibit poorer cycle characteristics than the lithium secondary batteries of Examples 3 to 5 using as a binder a copolymer of PVA and ionically substituted acrylate according to the present invention. Particularly, it can be seen that THE lithium secondary battery of Comparative Example 2 has very low capacity at 0 to 50 cycles. This is because a low electrode adhesive force causes resistance to be increased, so that a great reduction in capacity in evaluation of initial life may appear.

1. A binder for a secondary battery electrode, the binder being a copolymer comprising:
a repeating unit derived from a polyvinyl alcohol (PVA); and
a repeating unit derived from an ionically substituted acrylate.

2. (canceled)

3. The binder of claim 1,
wherein the copolymer comprises the repeating unit derived from a polyvinyl alcohol (PVA) and the repeating unit derived from an ionically substituted acrylate at a weight ratio of 6:4 to 8:2

4. The binder of claim 1,
wherein the ionically substituted acrylate is at least one salt selected from the group consisting of sodium acrylate and lithium acrylate.

5. The binder of claim 1,
wherein the copolymer is a block copolymer formed by including the repeating unit derived from a polyvinyl alcohol (PVA) and the repeating unit derived from an ionically substituted acrylate.

6. The binder of claim 1,
wherein the copolymer has a weight average molecular weight of 100,000 to 500,000.

7. A secondary battery electrode composition comprising: an electrode active material; a conductive material; a binder; and a solvent,
wherein the binder is the binder according to claim 1.

8. The secondary battery electrode composition of claim 7,
wherein the electrode active material comprises any one or more carbon-based material selected from the group consisting of soft carbon, hard carbon, natural graphite, artificial graphite, kish graphite, pyrolytic carbon, mesophase pitch based carbon fiber, mesocarbon microbeads, mesophase pitches, and petroleum or coal tar pitch derived cokes.

9. The secondary battery electrode composition of claim 8,
wherein the electrode active material further comprises a Si-based material.

10. The secondary battery electrode composition of claim 9,
wherein the Si-based material is comprised in an amount of 5 wt % to 20 wt %, based on a total weight of the electrode active material.

11. The secondary battery electrode composition of claim 7,
wherein the solvent comprises an aqueous solvent.

12. The secondary battery electrode composition of claim 7,
wherein the secondary battery electrode composition comprises, on the basis of the total weight thereof, 45 wt % or more of solid matters including the electrode active material, the conductive material, and the binder.

13. A secondary battery electrode comprises an active material layer comprising an electrode active material, a conductive material, and a binder,
wherein the binder is the binder according to claim 1.

14. The secondary battery electrode of claim 13,
wherein the electrode active material comprises any one or more carbon-based material selected from the group consisting of soft carbon, hard carbon, natural graphite, artificial graphite, kish graphite, pyrolytic carbon, mesophase pitch based carbon fiber, mesocarbon microbeads, mesophase pitches, and petroleum or coal tar pitch derived cokes.

15. The secondary battery electrode of claim 14,
wherein the electrode active material further comprises a Si-based material.

16. The secondary battery electrode of claim 15,
wherein the Si-based material is comprised in an amount of 5 wt % to 20 wt %, based on the total weight of the electrode active material.

17. A secondary battery comprising: a positive electrode; a negative electrode; a separator interposed between the positive electrode and the negative electrode; and an electrolyte, wherein the negative electrode is the electrode according to claim 13.
